(19) United States
(12) Patent Application Publication
(10) Pub. No.: US 2025/0052383 A1
(43) Pub. Date: Feb. 13, 2025

(54) PARALLEL INDUSTRIAL LAMP

(71) Applicant: Yuyao Yunjin Electrical Appliance Co., Ltd., Yuyao (CN)

(72) Inventor: Jun Li, Yuyao (CN)

(21) Appl. No.: 18/631,390

(22) Filed: Apr. 10, 2024

(30) Foreign Application Priority Data
Aug. 9, 2023 (CN) 2023221638303

(51) Int. Cl. F21S 4/10; F21V 19/04; F21V 31/00

(52) U.S. Cl. CPC F21S 4/10; F21V 19/04; F21V 31/005

(57) ABSTRACT

A parallel industrial lamp relates to the technical field of lamps and comprises a lamp base and a bulb radiator, the bottom of the lamp base is provided with a threaded contact lamp holder, the interior of the bulb radiator is provided with a conductive thread head that is threaded with the threaded contact lamp holder, the bottom of the conductive thread head is also provided with a light panel electrically connected to it, the bottom of the lamp base is embedded with a sealing ring, the top of the bulb radiator is provided with a sealing press ring whose top end extends to the inside of the lamp base and compresses the sealing ring, a lampshade is arranged at the bottom of the bulb radiator, the outer ring of the bulb radiator is provided with no less than one heat dissipation groove.

### 1. TECHNICAL FIELD

The invention relates to the technical field of lamps, in particular to a parallel industrial lamp.

### 2. BACKGROUND ART

Industrial lighting comprises indoor lighting, outdoor facility lighting, station and field lighting, underground lighting, road lighting, security lighting, obstacle lighting, etc. Parallel industrial lights are generally used for factory workshop lighting, where multiple lamps are connected in parallel on one wire to achieve wide-area lighting.

Currently, the conductive connection between the lamp panel and the lamp base of parallel industrial lamps is mostly achieved through wires, with the two ends of the wires fixed by screws. When maintenance is required, it is necessary to remove the screws, disconnect the wires, and take out the light bulbs. This design results in a very slow process for replacing the lamps later on, which no longer meets the needs of users.

### 3. SUMMARY OF THE INVENTION

The invention provides a parallel industrial lamp to solve the problems in the background art.

To realize the above objects, the invention provides the following technical scheme: a parallel industrial lamp comprises a lamp base and a bulb radiator, the bottom of the lamp base is provided with a threaded contact lamp holder, the interior of the bulb radiator is provided with a conductive thread head that is threaded with the threaded contact lamp holder, the bottom of the conductive thread head is also provided with a light panel electrically connected to it.

Further, the bottom of the lamp base is embedded with a sealing ring, the top of the bulb radiator is provided with a sealing press ring whose top end extends to the inside of the lamp base and compresses the sealing ring.

Further, a lampshade is arranged at the bottom of the bulb radiator.

Further, the outer ring of the bulb radiator is provided with no less than one heat dissipation groove.

Further, a parallel wire is connected to the top of the lamp base, the number of the lamp bases is not less than one, multiple lamp bases are connected in parallel through the parallel wire.

Further, a hook is arranged on the top of the lamp base.

Compared with the existing technology, the invention provides a parallel industrial lamp, which has the following advantageous effects:
compared to parallel lamps on the market that are connected by screws and wires, this parallel industrial lamp uses the conductive thread head and a threaded contact lamp holder for connection. This design allows for both mechanical and electrical connections to be established simultaneously; the disassembly process is simple and quick, ensuring efficient maintenance; the structure is streamlined, which is conducive to manufacturing, cost-effective, and has broad application prospects.

### 4. BRIEF DESCRIPTION OF ACCOMPANY DRAWINGS

FIG. 1 is a schematic diagram of the structure of the invention;

FIG. 2 is a schematic diagram of the separation state of the lamp base and the bulb radiator of the invention;

FIG. 3 is an exploded view of the structure of the invention;

FIG. 4 is a cross-sectional view of the structure of the invention.

In the figures: 1 lamp base; 11 threaded contact lamp holder; 12 sealing ring; 13 parallel wire; 14 hook; 2 bulb radiator; 21 conductive thread head; 22 sealing press ring; 23 light panel; 24 lampshade; 25 heat dissipation groove.

### 5. SPECIFIC EMBODIMENT OF THE INVENTION

The technical schemes in the embodiments of the invention will be clearly and completely described below in combination with the accompanying drawings in the embodiments of the invention. Obviously, the described embodiments are only part of the embodiments of the invention, not all embodiments. Based on the embodiments of the invention, all other embodiments obtained by those of ordinary skill in the art without creative efforts shall fall within the protection scope of the invention.

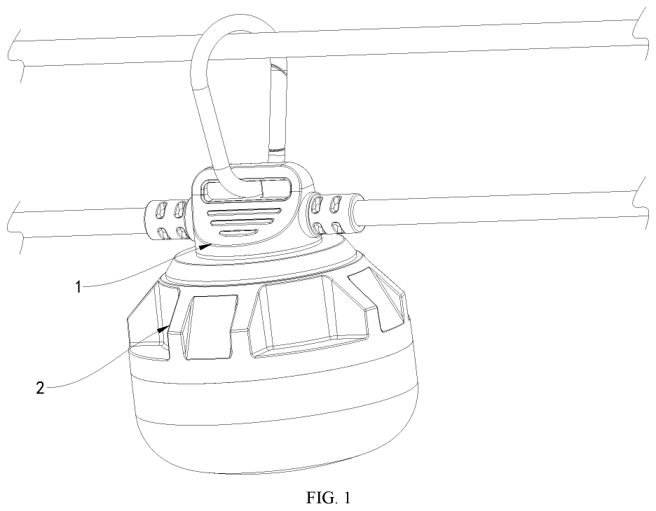

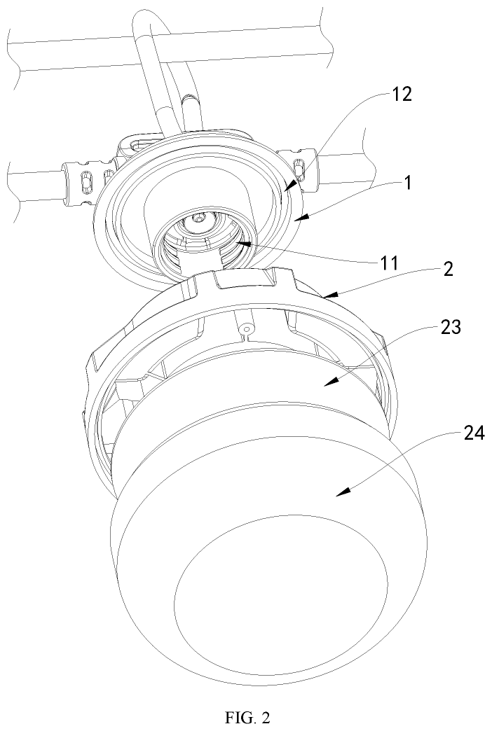

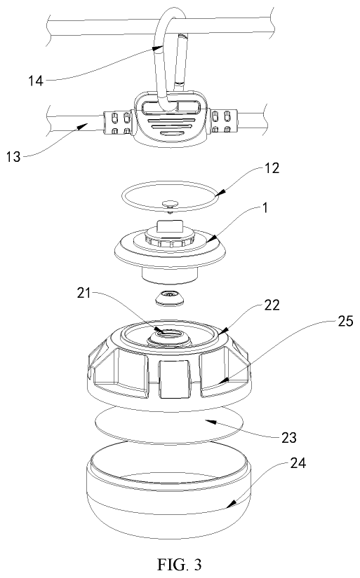

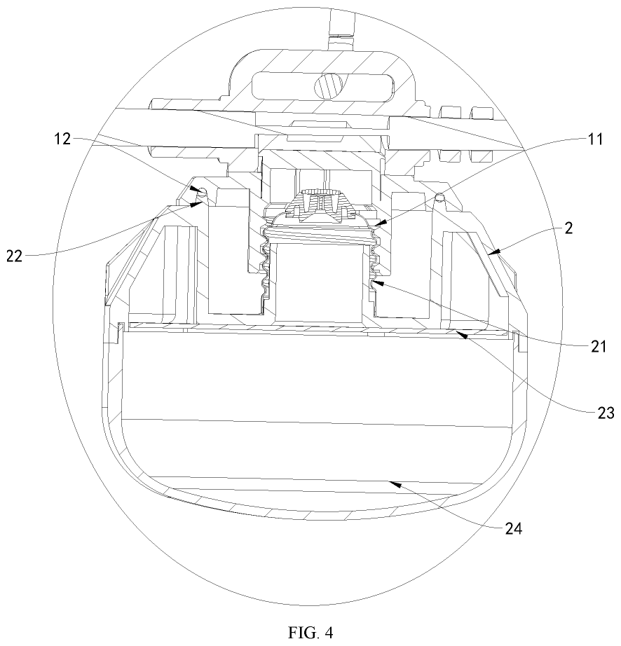

Please refer to FIG. 1-4, a parallel industrial lamp comprises a lamp base 1 and a bulb radiator 2, the bottom of the lamp base 1 is provided with a threaded contact lamp holder 11, the interior of the bulb radiator 2 is provided with a conductive thread head 21 that is threaded with the threaded contact lamp holder 11, the bottom of the conductive thread head 21 is also provided with a light panel 23 electrically connected to it.

Specifically, the bottom of the lamp base 1 is embedded with a sealing ring 12, the top of the bulb radiator 2 is provided with a sealing press ring 22 whose top end extends to the inside of the lamp base 1 and compresses the sealing ring 12. The assembly is completed by aligning the conductive thread head 21 with the threaded contact lamp holder 11, and rotating the bulb radiator 2 to screw the conductive thread head 21 into the interior of the threaded contact lamp holder 11; simultaneously, the sealing press ring 22 is pressed into the interior of the lamp base 1 to tightly compress the sealing ring 12, ensuring the sealing performance at the connection between the conductive thread head 21 and the threaded contact lamp holder 11.

Specifically, a lampshade 24 is arranged at the bottom of the bulb radiator 2, the lampshade 24 is used to cover the lamp panel 23; after the lamp panel 23 is lit, the light is transmitted through the lampshade 24.

Specifically, the outer ring of the bulb radiator 2 is provided with no less than one heat dissipation groove 25; referring to FIG. 1, the setting of the heat dissipation grooves 25 not only increases the heat dissipation area of the outer ring of the bulb radiator 2, but also facilitates the user to rotate the bulb radiator 2 by hand, further ensuring the efficiency of subsequent maintenance.

Specifically, a parallel wire 13 is connected to the top of the lamp base 1, the number of the lamp bases 1 is not less than one, multiple lamp bases 1 are connected in parallel through the parallel wire 13, a hook is arranged on the top of the lamp base 1, the lamp base 1 can be hung through the hook 14.

In conclusion, compared to parallel lamps on the market that are connected by screws and wires, this parallel industrial lamp uses the conductive thread head 21 and a threaded contact lamp holder 11 for connection. This design allows for both mechanical and electrical connections to be established simultaneously; the disassembly process is simple and quick, ensuring efficient maintenance; the structure is streamlined, which is conducive to manufacturing, cost-effective, and has broad application prospects.

Although the embodiments of the invention have been shown and described, those of ordinary skill in the art should understand that various changes, modifications, substitutions and variants can be made to these embodiments without departing from the principles and spirit of the invention, the scope of the invention is defined by the appended claims and their equivalents.

1. A parallel industrial lamp comprises a lamp base and a bulb radiator, the bottom of the lamp base is provided with a threaded contact lamp holder, the interior of the bulb radiator is provided with a conductive thread head that is threaded with the threaded contact lamp holder, the bottom of the conductive thread head is also provided with a light panel electrically connected to it.

2. The parallel industrial lamp of claim 1, the bottom of the lamp base is embedded with a sealing ring, the top of the bulb radiator is provided with a sealing press ring whose top end extends to the inside of the lamp base and compresses the sealing ring.

3. The parallel industrial lamp of claim 1, a lampshade is arranged at the bottom of the bulb radiator.

4. The parallel industrial lamp of claim 1, the outer ring of the bulb radiator is provided with no less than one heat dissipation groove.

5. The parallel industrial lamp of claim 1, a parallel wire is connected to the top of the lamp base, the number of the lamp bases is not less than one, multiple lamp bases are connected in parallel through the parallel wire.

6. The parallel industrial lamp of claim 1, a hook is arranged on the top of the lamp base.
